(19) United States
(12) Patent Application Publication
(10) Pub. No.: US 2022/0122119 A1
(43) Pub. Date: Apr. 21, 2022

(54) ELECTRONIC ADVERTISING CAMPAIGN TRACKING

(71) Applicant: MARCHEX SALES, LLC., Las Vegas, NV (US)

(72) Inventors: William Li, Sammamish, WA (US); Jason Clark, Burlington (CA); Michael Kunugiyama, Lynnwood, WA (US)

(73) Assignee: MARCHEX SALES, LLC., Las Vegas, NV (US)

(21) Appl. No.: 17/072,183

(22) Filed: Oct. 16, 2020

(51) Int. Cl. G06Q 30/02; G06Q 10/10; G06F 16/28; G06N 5/04; G06N 20/00

(52) U.S. Cl. CPC G06Q 30/0243; G06Q 30/0201; G06Q 10/10; G06Q 30/0255; H04W 4/14; G06N 5/04; G06N 20/00; G06Q 30/0204; G06F 16/288

(57) ABSTRACT

Service provider (SP) system within a special purpose hardware platform operable to present an advertisement campaign to a potential customer, including a contact indicium. The SP system may include a contact interface, such as a short message service terminal, telephone interface, or web-based server interface, for establishing contact with the prospective customer. The contact interface may be used to determine, and store contact information associated with the prospective customer, which is associated with the advertisement campaign and provided to the service provider for further processing.

### CROSS-REFERENCE TO RELATED APPLICATION INFORMATION

This application is related to U.S. application Ser. No. 16/901,775, filed Jun. 15, 2020, U.S. application Ser. No. 13/294,436 filed Nov. 11, 2011, Now U.S. Pat. No. 10,685,373, U.S. application Ser. No. 11/958,188, Now U.S. Pat. No. 8,442,862, and U.S. Provisional Application Ser. No. 60/865,671, filed Nov. 14, 2006. The entirety of each of these applications are incorporated herein by reference.

### BACKGROUND

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Advertisers have developed several strategies in an attempt to maximize the value of such advertising. In one strategy, advertisers use popular presences or means for providing interactive media or services (referred to herein as “Web sites” without loss of generality) as conduits to reach a large audience. Using this first approach, an advertiser may place ads on the home page of the New York Times Web site, or the USA Today Web site, for example. In another strategy, an advertiser may attempt to target its ads to narrower niche audiences, thereby increasing the likelihood of a positive response by the audience. For example, an agency promoting tourism in the Costa Rican rainforest might place ads on the ecotourism-travel subdirectory of the Yahoo Web site. An advertiser will normally determine such targeting manually.

Regardless of the strategy, Web site-based ads (also referred to as “Web ads”) are typically presented to their advertising audience in the form of “banner ads”—i.e., a rectangular box that includes graphic components. When a member of the advertising audience (referred to herein as a “viewer” or “user” without loss of generality) selects one of these banner ads by clicking on it, embedded hypertext links typically direct the viewer to the advertiser's Web site. This process, wherein the viewer selects an ad, is commonly referred to as a “click-through” (“Click-through” is intended to cover any user selection). The ratio of the number of click-throughs to the number of impressions of the ad (i.e., the number of times an ad is displayed) is commonly referred to as the “click-through rate” of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's web page, and consummates a purchase there before leaving that web page. Alternatively, a conversion may be defined as a user being shown an ad, and making a purchase on the advertiser's web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Web site or Web page, etc. Often, if user actions do not indicate a consummated purchase, they may indicate a sales lead, although user actions constituting a conversion are not limited to this. Indeed, many other definitions of what constitutes a conversion are possible. The ratio of the number of conversions to the number of impressions of the ad (i.e., the number of times an ad is displayed) is commonly referred to as the conversion rate. If a conversion is defined to occur within a predetermined time since the serving of an ad, one possible definition of the conversion rate might only consider ads that have been served more than the predetermined time in the past.

Despite the initial promise of Web site-based advertisement, there remains several problems with existing approaches. Although advertisers are able to reach a large audience, they are frequently dissatisfied with the return on their advertisement investment.

Advertisers find electronic advertising to be one medium in which the effectiveness of advertising can be measured in such a way as to appropriately budget advertising expenditures to target the most effective types of advertising placements. It is desirable to extend this sort of precision measurement to advertising campaigns involving various forms of contact with potential customers and leads, and to measure response rates for campaigns utilizing such contact, whether in electronic, print, broadcast or, any media.

### BRIEF DESCRIPTION OF THE DRAWINGS

FIG. 1 illustrates an example server provider (SP) system in which certain examples of the present disclosure may be implemented.

FIG. 2 shows one example architecture that may be operable to associate message data initiating from the SMT with advertising campaigns to measure response rates of advertisement campaigns utilizing short message service (SMS) protocols, in accordance with an example of the disclosure.

FIG. 3 shows one example web proxy architecture, in accordance with an example of the disclosure.

FIG. 4 shows one example process using a customer contact information form, in accordance with an example of the disclosure.

### DETAILED DESCRIPTION

Examples described herein are configured to track text messages and web-based chats with potential customers in the course of advertising campaigns in various media. As discussed further below, a system may be operable to present an advertisement campaign to a potential customer, where the advertisement campaign includes a contact indicium. The contact indicia may be selected by a service provider in association with a specific campaign to which the advertisement relates. The examples address a computer-centric and Internet-centric problem of a service provider assigning contact indicia to a user located at a terminal device for a specific advertisement campaign of many advertisement campaigns.

The system includes one or more special purpose computer devices for retrieving an electronic contact mechanism, such as a web page or an interactive form, and inserting an associated contact indicium associated with an advertising campaign, in response to a prospective customer requesting the electronic contact mechanism. The system may include a contact interface, such as a short message service terminal, a telephone interface, or a web-based server interface, for establishing contact with the prospective customer. The contact interface may also be used for determining and storing contact information associated with the prospective customer. The contact information can include a telephone number, an IP address, or any related information about the prospective customer. The contact information may be associated with the advertisement campaign and provided to the service provider for further processing.

The disclosed methods and system may be implemented as computer programs or application software on one or more computing devices that process contact information associated with the prospective customer collected by a data management system.

There are several advantages of the disclosed examples. For example, the system permits an advertiser to associate specific and distinct contact information associated with the prospective customer with advertising campaigns. The system further modifies advertiser-provided information in response to the advertising campaign to which a potential customer responds and includes the associated contact indicium in the modified advertiser information. The system processes messages received at the associated contact indicium and provides reports to advertisers of the message data associated with the respective advertising campaigns.

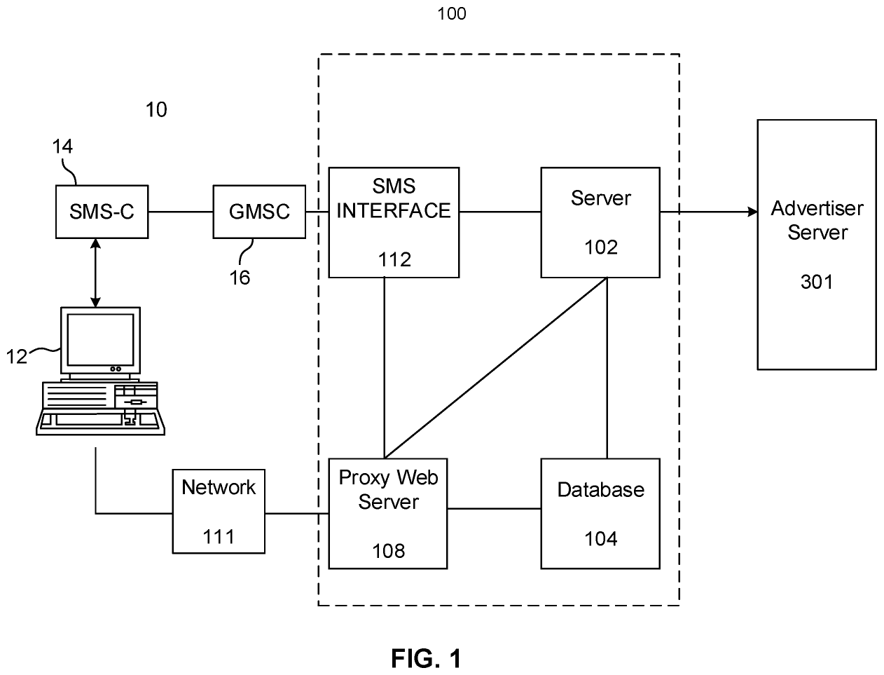

FIG. 1 illustrates an example server provider (SP) system 100 in which certain examples of the present disclosure may be implemented. The SP system 100 includes a server 102, a non-transitory database 104, and a short message service (SMS) interface 112. The SP system 100 is connected to a cellular communications system 10 and to an advertiser server 301. The cellular communications system 10 includes a short message terminal (SMT) 12, a short message service center (SMS-C) 14, and a gateway mobile services switching center (GMSC) 16. The SMT 12 is connected to the SMS-C 14. A user may originate or receive a short message via the SMT 12, which can be, for example, one of a plurality of SMTs in a data network. The SMS-C 14 functions as a short message interface unit between the data network and the GMSC 16.

The SMS-C 14 is operable to store and forward short messages to and from SMT 12 (and also to and from one or more mobile stations in the data network). SMS-C 14 can be a GSM or similarly configured type of SMS-C. Alternatively, a GMSC configured for storing and forwarding short messages may be substituted for SMS-C 14. As such, SMT 12 would be connected directly to the GMSC (e.g., GMSC 16). GMSC 16 is connected by a signaling network to the short message service interface 112 of the SP system 100.

In some examples, the SP system 100 may include a proxy web server 108 for proxying documents, such as HTML based web documents, on the Internet. A user located at the SMT 12 may also access the SP system 100 via the Internet or by some other network protocol, for example through the proxy server 108 or directly through the server 102.

Users located at the SMT 12 are able to access the system 100 via a network 111. The network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between the LANs, enabling messages to be sent from one LAN to another. Furthermore, remote computers and other related electronic devices could be remotely connected to either LANs or WANs via a modem and a temporary telephone link. Network 111 includes any communication method by which information may travel between computing devices.

The SMT 12 may include virtually any computing device that typically connects using a wired communications medium such as e.g., telephones, televisions, video recorders, cable boxes, gaming consoles, personal computers, multiprocessor systems, microprocessor-based or programmable consumer electronics, network PCs, or the like. The SMT 12 may further be configured to include a client application that enables the user to log into a user account that may be managed by the service provider.

The server 102 may include virtually any network computing device that is specially configured to associate message data initiating from the SMT 12 with advertising campaigns. Devices that may operate as server 102 include, but are not limited to, personal computers, desktop computers, multiprocessor systems, microprocessor-based or programmable consumer electronics, network PCs, servers, network appliances, and the like.

Although the server 102 is illustrated as a distinct network device, the disclosed principles are not so limited. For example, a plurality of network devices may be configured to perform the operational aspects of server 102. For example, data collection might be performed by one or more set of network devices, while processing the collected data to associate message data initiating from the SMT 12 with advertising campaigns may be performed by one or more other network devices.

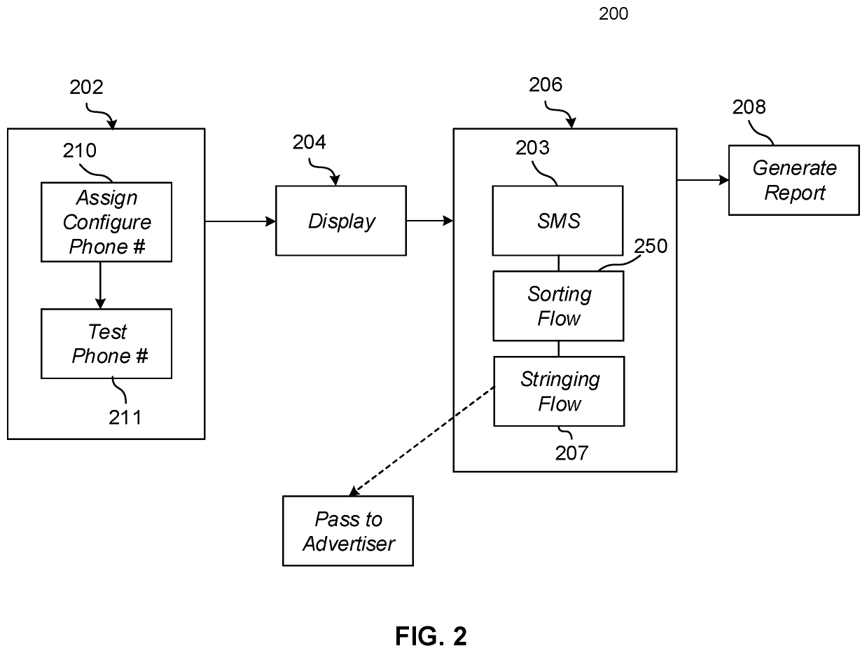

FIG. 2 shows one example architecture 200 that may be operable to associate message data initiating from the SMT 12 with advertising campaigns to measure response rates of advertisement campaigns utilizing short message service (SMS) protocols, in accordance with an example of the disclosure. The SP System 100 of FIG. 1 may be configured to operate in four phases: an assigning and configuring phase 202, a displaying phase 204, tracking phase 206, and report generation phase 208.

Architecture 200 may include many more phases than those shown. The phases shown, however, are sufficient to disclose an illustrative example for practicing the disclosed principles. Architecture 200 may be executed across components of FIG. 1, including, for example, the server 102.

The assigning and configuring phase 202 includes assigning and configuring one or more associated contact indicium (e.g., phone numbers) to various advertising campaigns 210. The associated contact indicium may also include a unique email address, or a web browser, web chat page specifically associated with an advertisement campaign. In some examples, the assigned phone numbers may originate from blocks of phone numbers pre-purchased from one or more phone service carriers. In the assigning and configuring phase 210, one or more phone numbers are assigned and configured in the database 104 to correspond to one or more advertising campaigns, as described in greater detail below.

Optionally, prior to or concurrent with the assignment and configuration phase 202, the assigned phone numbers may be tested in a phone test phase 211. In some examples, before a phone number is assigned to an advertising campaign, the phone number is cleaned to avoid unwanted phone traffic due to previous use of the phone numbers by previous users. This cleaning procedure may employ any suitable mechanism for limiting such unwanted use, such as monitoring phone traffic over an interval of time to determine if unwanted use falls below a defined threshold.

The displaying phase 204 includes displaying the assigned phone number(s) via various media to recipients, such as a user associated with the SMT 12 of FIG. 1, of an advertising campaign(s), as described in greater detail below. A user may originate or receive a short message via the SMT 12, which can be, for example, one of a plurality of SMTs in a data network.

The tracking phase 206 includes tracking, sorting, and mapping short messages delivered to the displayed phone number(s). A user sends a short message via the SMT 12 to the phone number displayed in phase 204 and accesses the SP system 100 via the SMS interface 112. The short message is then routed through the sorting flow at sub-process 250 of the SP system 100, as shown in FIG. 2 and described in greater detail below. In the sorting flow 250, the message data of a sequence of short messages can be received and stored by the server 102. In addition, the server 102 records in a log, which may be kept in the database 104, that a short message was received via the SMT 12 at the displayed phone number. The short message may be one message in a plurality of short messages received via the SMT 12.

The short messages are sorted at sub-process 250. In some examples, short messages may be received via the SMT 12 within minutes of one another, hourly or even shorter intervals. The short messages are parsed to identify commonality and relevance. The sub-process 250 includes copying of data resulting from the received short messages into various storage locations and registries within the database 104. Parsing may include, among other actions, matching one or more short messages to one or more entities, extracting event types, event instances, or the like. Any data translations or registrations may also be performed upon the incoming data at sub-process 250.

The data is then provided to sub-process 207, where various short messages may be identified and mapped to common events. For example, in one example, a service provider may identify events referenced within a series of short messages received during a specified time interval. Moreover, a service provider may also identify web browsing events of the user using, for example, a web or tracking identifier (e.g., IP address), where the web browsing events occurred within the specified time interval. Sub-process 207 may also examine the incoming event instances, and so forth, to generate common events with common terminology, form, formats, etc. These common data points may be generated using, for example, a machine-learning (ML) model to associate specific and distinct contact information associated with the prospective customer with advertising campaigns.

Machine-learning is a field of study that gives computers the ability to learn without being explicitly programmed. Machine-learning explores the study and construction of algorithms, also referred to herein as tools, which learn from existing data and make predictions about new data. Such machine-learning tools operate by building a model from example training data in order to make data-driven predictions or decisions expressed as outputs or assessments (e.g., identifying short messages and mapping to common events). Although example examples are presented with respect to a few machine-learning tools, the principles presented herein may be applied to other machine-learning tools.

Once the various short messages are identified and mapped to common events at step 207, the short message may optionally be sent to the advertiser of the advertising campaign for further processing by the advertiser server 301, or otherwise terminated. In some examples, the service provider is unable to receive a tracking identifier. The service provider is operable to associate specific and distinct contact information associated with the prospective customer with advertising campaigns. For example, the service provider may simply provide one or more associated contact indicium (e.g., phone numbers), assigned to various advertising campaigns 210, to the end user at predetermined time intervals. The identified phone number assigned to the advertising campaign may be provided every so often during time intervals, separated by a predetermined waiting period (e.g., minutes or hours). The phone number assigned to the advertising campaign, solely or in combination with an end user's IP address may be used to associate the prospective customer with an advertising campaign.

In some examples, the SP system 100 may provide unique phone numbers to a select group of end users to create a narrower pool of potential users utilizing the phone number assigned to the advertising campaign.

In some examples, a phone number assigned to the advertising campaign and an end user's IP address may be unavailable for associating the prospective customer with an advertising campaign. In such instances, third-party data may be leveraged to generate a joint cookie to associate which web content has been exposed to the end user. This third-party data may be used, for example, to make an association with a later phone call, short message, or web chat input (discussed below).

In the report generation phase 208, real time reports may be generated based on the data collected by the SP system 100. These reports may be made accessible to an advertiser of the advertising campaign. The received data may include such identifying data as the caller ID information, the destination number, the time the short messages were received, the number of short messages in a series (determined at step 207), web content exposed to the end user, and other information, along with the content of the short messages.

In some examples, the reports may be generated by the system and viewed over the network 111 by the advertiser server 301, upon access to the server 102, of the SP system 100.

The advertiser server 301 may assign different telephone numbers to each of multiple advertising campaigns, to permit the advertiser server 301 to measure the relative response of such campaigns. In some examples, phone numbers are assigned by the advertiser server 301 based on various criteria, described in greater detail below, and these assigned phone numbers are displayed to a user associated with the SMT 12 based upon the campaign the user is viewing. The display can be any suitable media on which phone numbers can be communicated to the customer, such as on a web page, a document, a brochure, a radio, advertisement, a newspaper, periodical, or journal, a podcast, a telephone call, and the like.

During the configuration phase 202, phone numbers are assigned to advertising campaigns. Each advertising campaign includes a defined transaction for which the advertiser server 301 of the campaign desires to track information. For example, the advertiser server 301 may want to track information relating to which of several particular advertising campaigns may have resulted in a short message from a user associated with the SMT 12. In one example, the advertising campaign may be an Internet accessible web page displaying one or more phone numbers in which each phone number is assigned based on which Uniform Resource Locator (URL) referred the lead, which search engine the lead used, which search term(s) or keyword(s) were used, and/or other criteria.

Furthermore, on-page variables may be retrieved. Specifically, on-page variables may include any additional information that can be retrieved from the web page. For example, the page variable can include: variable identification number (VIN), alternative output formats (all alternative formats for a given page), aliases of a webpage, data specific to this type of page, the date associated with the page, the description for the page, the path of the folder containing the content file, a Boolean if the content of the page is marked as draft in the front matter, an approximate number of words in the content, meta keywords for the content of the page, the page's kind, the current format for a given page, a collection of associated pages, etc. The retrieved on-page variables may be implemented to make an association with the phone numbers assigned to advertising campaigns.

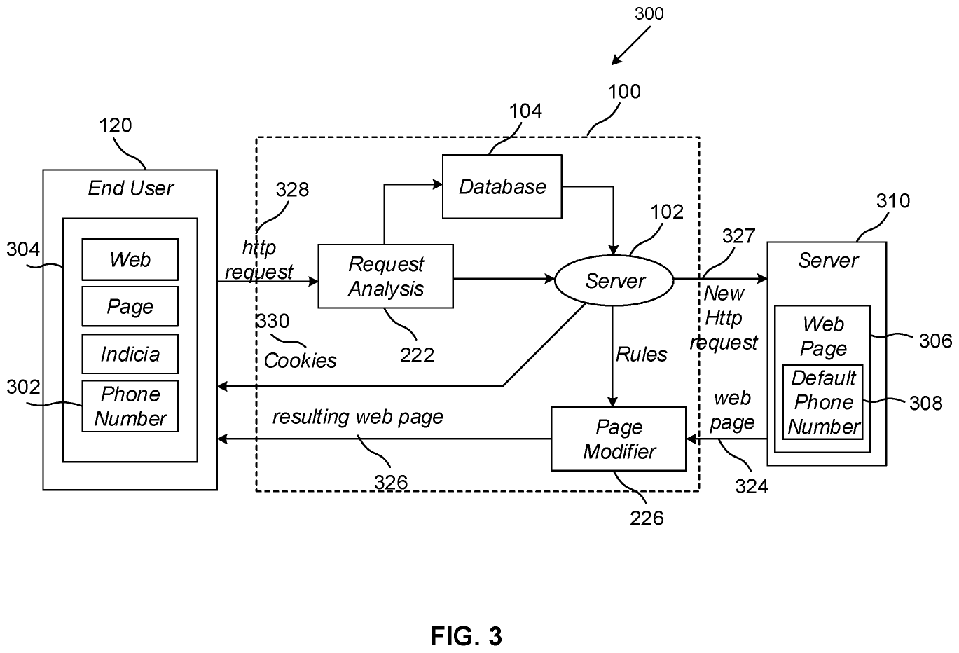

FIG. 3 shows an example web proxy architecture 300, in accordance with an example of the disclosure. The web proxy architecture 300 include an end user 120, the SP system 100, and a server 310. In some examples, the server 310 may be configured as the advertiser server 301 of FIG. 1. In other examples, the server 310 may be a different service provider, acting on behalf of the advertiser server 301 of FIG. 1. The end user 120 may be the same as the SMT 12 in some examples. In alternative examples, the end user 120 may be a different terminal device associated with the user. For example, the end user 120 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. The end user 120 may further be configured to include a client application that enables the user to log into a user account that may be managed by the service provider.

At the end user 120, a phone number 302 may be assigned to a particular advertising campaign. In an example advertising campaign, the phone number 302 will be displayed on a web page which is accessible to a potential user associated with the SMT 12 via the Internet. The web page may be based on an existing web page 306 that resides on the server 310. The existing web page 306 may be a home page or contact page of the advertiser server 301.

The existing web page 306 may contain at least one existing or default phone number 308, provided by the advertiser server 301. In order to track responses to an advertisement associated with the campaign, the SP system 100 may be operable to replace the existing phone number 308 with a campaign phone number 302 while otherwise retaining all the remaining data and formatting of the web page 306. A resulting web page is created and displayed to the end user 120, containing the assigned campaign phone number 302 instead of the existing phone number 308. Otherwise the web pages presented to the user and the web pages 306 of the advertiser may be substantially identical.

In some examples, the server 102 may be used to automatically modify and display the assigned campaign phone number 302 on the pre-existing static or dynamically generated webpage 306. The server 102 may be operable to receive an http request 328 from the end user 120 in response to an advertisement associated with the advertising campaign. The SP system 100 is operable to analyze various request parameters at sub-process 222, such as the request URL, the http referrer, cookies, and the like. The database 104 may contain stored configuration data for a particular ad campaign, such as, for example, a new web URL and set of page modifications rules 226. The configuration data, stored in the database 104 may include, for example, the telephone number 302.

In some examples, the server 102 may send a new http request 327 to the server 310 for the existing web page 306 which is intended to be modified. The server 310 is operable to send the web page 306 over the Internet to the SP system 100. The modification rules 226 may be applied to the web page 306 to, for example, assign a new URL to the modified web page 304. The new web page 304 may also be generated by referencing stored modification rules 226 and modifying the existing web page 306 to display the assigned phone number 302 in place of the existing phone number 308.

For example, in a first advertising campaign a first phone number may be displayed if the user's referring URL is a particular URL corresponding to a link presented in an advertisement. In a second advertising campaign a second phone number may be displayed for a different referring URL, such as the URL of a particular search engine. In a third advertising campaign, a third phone number may be assigned if a particular search term was used to locate the existing web page. These rules are described in greater detail below. When a short message is sent to one of the assigned numbers, the SP system 100 is operable to determine which advertising campaign generated the lead based upon the phone number utilized by the end user 120. For example, if the short message was received at the second phone number, it would be known that a user associated with the end user 120 viewed the displayed second phone number in connection with the second advertising campaign. For example, a customer referring URL may indicate that the customer's http request 328 shows that the customer has utilized a particular search engine, such as GOOGLE®.

Once the page modification rules are applied to the existing web page 306 by the server 102, and the page is thus modified, the resulting modified web page 304 may be delivered and displayed 326 to the end user 120. An example modification may include one or more contact phone numbers 308 on the existing page 306 being replaced with the assigned phone number 302 so that when the short message is received via the assigned phone number 302, the SP system 100 recognizes the message initiated to a phone number other than the existing phone numbers 308. Once in the SP system 100, the short message can be tracked and the passed on to the advertiser server 301.

In some examples, a cookie 330 may be delivered to the end user 120 with various cookie parameter(s) to facilitate future requests. Moreover, the existing web page 306 may be modified to contain JavaScript. For example, when a web page 306 is requested directly from the server 310, the JavaScript executes and call the SP system 100. The request analysis sub-process 222 may analyze the request as described above. The HTML of the web page 306 is modified to replace the phone number 308 with phone number 302 on the client side. The modified web page 302 is delivered and displayed 326 to the end user 120, as described above.

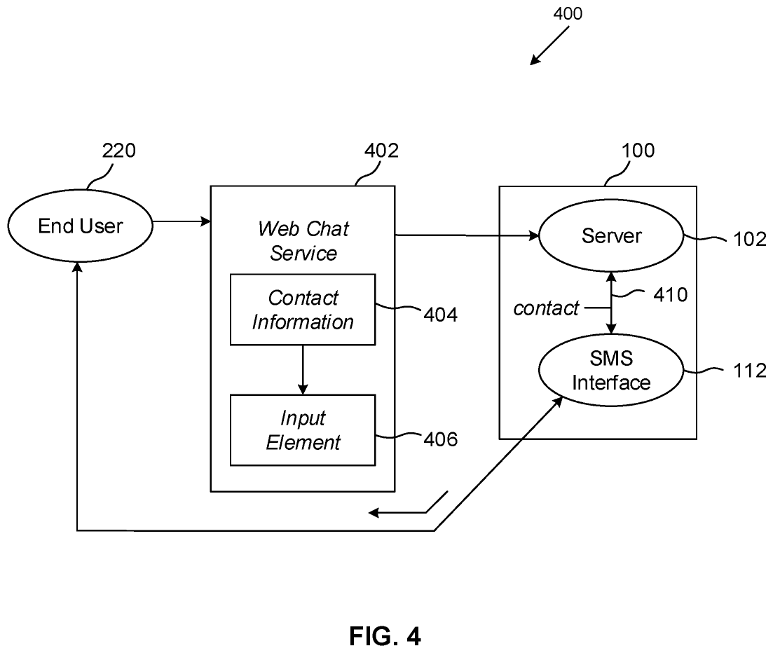

FIG. 4 shows one example process 400 using a web chat service or a web page form, in accordance with an example of the disclosure. The process 400 includes an end user 220, a web chat service 402, and the SP system 100. In some examples, the advertiser server 301 may provide the web chat service 402 to the end user 220. Alternatively, the SP system 100 may provide the web chat service 402 to the end user 220.

The web chat service 402 may be operable as an intelligent automated agent for an advertiser server 301 or SP system 100. In one embodiment, the web chat service 402 is an application running on a server computer. The web chat service 402 may learn, for example, by artificial intelligence, to perform the roles of a live agent without the limitations of a live agent. In one exemplary embodiment, the web chat service 402 responds to the end user 220 in real time and in the same language (spoken or written) received from the end user 220. For example, the web chat service 402 may have an artificial intelligence engine adapted to learn over time from its present interactions and use that knowledge to respond more appropriately to future interactions.

The end user 220 may be the same as the SMT 12 of FIG. 1, in some examples. In alternative examples, the end user 220 may be a different terminal device associated with the user. For example, the end user 220 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. The end user 220 may further be configured to include a client application that enables the user to log into a user account that may be managed by the service provider.

Contact information 404 related to the end user 220 may be provided to the advertiser server 301 or SP system 100 via the web chat service 402. The contact information 404 can include a telephone number, an IP address, or any related information about the prospective customer. The end user 220 may be associated with an IP address, which is received at the web chat service 402, provided by a SP system 100. In alternative embodiments, the IP address of the end user may be received at the web chat service 402, provided directly from an advertiser server 301 to the end user 220.

In some examples, the end user 220 may be prompted to submit contact information 404 (e.g., a phone number 404) into the web chat service 402. In some examples, the end user 220 activates the web chat service 402, by activating an input element 406 of a HTML form. The contact information 404 may be transmitted to the SP system 100, in some examples. Alternatively, the contact information 404 may be transmitted to the advertiser server 301. Other means of collecting user information and transmitting same may also be implemented herein without parting from the scope of the present disclosure.

Message data received at the web chat service 402 may be tracked, sorted and/or mapped. For example, the message data of a sequence of short messages received at the web chat service 402 can be received and stored by the server 102. In addition, the server 102 records in a log, which may be kept in the database 104 of FIG. 1, that a short message was received via the end user 220 at the web chat service 402. The short message may be one message in a plurality of messages received at the web chat service 402.

The messages may be sorted and/or parsed to identify commonality and relevance. The server 102 may be configured to copy data resulting from the received short messages into various storage locations and registries within the data source 104, of FIG. 1. Parsing may include, among other actions, matching one or more short messages to one or more entities, extracting event types, event instances, or the like.

The messages received at the web chat service 402 may be identified and mapped to common events. For example, in one example, a service provider may identify events referenced within a series of short messages received during a specified time interval. Moreover, a service provider may also identify web browsing events of the end user 220 using, for example, a web or tracking identifier (e.g., IP address), where the web browsing events occurred within a specified time interval. The server 102 may be operable to also examine the incoming event instances, and so forth, to generate common events with common terminology, form, formats, etc. These common data points may be generated using, for example, a machine-learning (ML) model.

The contact information 403 received at the input element 406 may be transmitted to the server 102. In response, the SP system 100 may be operable to generate a contact event 410, for example a short message from the SMS interface 112 to the end user 220, at for example, the SMT 12 of FIG. 1.

In some examples, the contact event 410 may be originated from a phone number operatively selected to be associated with a specific advertisement campaign. In some examples of the disclosure, the existing web pages may be customized to include and/or exclude certain phone numbers on the existing web page. For example, the modification rules can specifically include certain phone numbers, such as the main number or the sales number of the advertising campaign client or exclude certain numbers, such as the sales or parts numbers of the advertising campaign client.

Additionally, the assigned phone numbers may be displayed as graphic images, such as jpeg images, instead of as hyperlinks when the phone numbers are displayed as HTML web-based content. In this embodiment, an existing phone number is replaced with pre-generated or a generated-on-the-fly graphic images to create the displayed web page.

The server 102 may include an application that runs a routine for replacing the existing phone numbers with the assigned numbers based on algorithms used for identifying and parsing phone numbers in html code. When the advertiser server 301 assigns telephone numbers to respective advertisement campaigns, the advertiser server 301 may also identify telephone numbers within the existing web page 306 to be replaced by the SP system 100.

It will be understood that each block of the processes, and combinations of blocks in the processes discussed above, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multiprocessor computer system. In addition, one or more blocks or combinations of blocks in the illustration may also be performed concurrently with other blocks or combinations of blocks, or even in a different sequence than illustrated without departing from the scope or spirit of the subject innovation. Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware-based systems, which perform the specified actions or steps, or combinations of special purpose hardware and computer instructions.

1. A computer implemented method for associating message data initiating from a user's short message terminal with advertising campaigns, said method being performed on a computing device and executed by a processor, said method comprising:
assigning one or more associated contact indicium to an advertising campaign;
storing configuration data including the advertising campaigns, at least one page modification rule, and the one or more associated contact indicium; and
outputting the associated contact indicium to either the short message terminal or a second terminal device associated with the user based on the at least one page modification rule; and
tracking and mapping at least one short message originated from the short message terminal of the user and made to the associated contact indicium.

2. The method of claim 1, wherein the associated contact indicium includes at least one of a phone number, unique email address, web browser, or web chat page specifically associated with an advertisement campaign.

3. The method of claim 1, further comprising receiving the short message via the short message terminal of the user.

4. The method of claim 1, further comprising receiving and storing message data of the at least one short message, the message data including at least one of contact indicium of the short message terminal of the user, IP address of either the short message terminal or the second terminal device associated with the user.

5. The method of claim 4, further comprising associating the contact indicium of the short message terminal of the user with at least one advertising campaign.

6. The method of claim 1, further comprising identifying web browsing events of the user using a web or tracking identifier.

7. The method of claim 1, further comprising providing the one or more associated contact indicium to the advertising campaign during predetermined time intervals, separated by a predetermined waiting period.

8. The method of claim 7, further comprising associating a contact indicium of the short message terminal of the user with at least one advertising campaign based on at least one of the one or more associated contact indicium to the advertising campaign or an IP address of either the short message terminal or the second terminal device associated with the user.

9. The method of claim 8, generating real time reports based on at least one of the one or more associated contact indicium to the advertising campaign or an IP address of either the short message terminal or the second terminal device associated with the user.

10. The method of claim 7, further comprising associating a contact indicium of the short message terminal of the user with at least one advertising campaign based on third-party data leveraged to generate a joint cookie to associate web content that has been exposed to the user.

11. The method of claim 10, further comprising generating real time reports based on third-party data leveraged to generate the joint cookie to associate web content that has been exposed to the user.

12. The method of claim 1, wherein the associated contact indicium is uniquely assigned to the advertising campaign, and the associated contact indicium is displayed to the user based upon the advertisement campaign the user is viewing.

13. A system for associating message data initiating from a short message terminal of a user with advertising campaigns, the system comprising:
a non-transitory data storage device; and
one or more special purpose computer devices that access and store data on the data storage device and employ at least one processor to perform actions, including:
assigning one or more associated contact indicium to an advertising campaign;
storing configuration data including the advertising campaigns, at least one page modification rule, and the one or more associated contact indicium;
displaying the associated contact indicium to either the short message terminal or a second terminal device associated with the user based on the at least one page modification rule; and
tracking and mapping at least one short message originated from the short message terminal of the user and made to the associated contact indicium.

14. The system of claim 13, wherein the associated contact indicium include at least one of a phone number, a unique email address, a web browser, or a web chat page specifically associated with an advertisement campaign.

15. The system of claim 13, further comprising receiving the short message via the short message terminal of the user.

16. The system of claim 13, further comprising receiving and storing message data of the at least one short message, the message data including at least one of contact indicium of the short message terminal of the user, IP address of either the short message terminal or the second terminal device associated with the user.

17. The system of claim 16, further comprising associating the contact indicium of the short message terminal of the user with at least one advertising campaign.

18. The system of claim 13, further comprising identifying web browsing events of the user using a web or tracking identifier.

19. The system of claim 13, further comprising providing the one or more associated contact indicium to the advertising campaign during predetermined time intervals, separated by a predetermined waiting period.

20. The system of claim 19, further comprising associating a contact indicium of the short message terminal of the user with at least one advertising campaign based on at least one of the one or more associated contact indicium to the advertising campaign or an IP address of either the short message terminal or the second terminal device associated with the user.

21. A computer implemented method for associating message data initiating from a web chat service provided at an end user's terminal device with advertising campaigns, said method being performed on a computing device and executed by a processor, said method comprising:
assigning one or more associated contact indicium to an advertising campaign;
storing configuration data including the advertising campaigns, at least one page modification rule, and the one or more associated contact indicium;
outputting the associated contact indicium to either the terminal device or a second terminal device associated with the web chat service based on the at least one page modification rule; and
tracking and mapping at least one short message originated from the short message terminal of the user and made to the associated contact indicium.

22. The method of claim 1, wherein the at least one page modification rule comprises assigning a new URL to a modified web page output to either the short message terminal or the second terminal device associated with the user.

23. The system of claim 13, wherein the at least one page modification rule comprises assigning a new URL to a modified web page output to either the short message terminal or the second terminal device associated with the user.

24. The method of claim 21, wherein the at least one page modification rule comprises assigning a new URL to a modified web page output to either the short message terminal or the second terminal device associated with the user.
